(19) United States
(12) Patent Application Publication
(10) Pub. No.: US 2002/0099734 A1
(43) Pub. Date: Jul. 25, 2002

(54) Scalable parser for extensible mark-up language

(75) Inventors: Amr F. Yassin, Ossining, NY (US); Yasser alSafadi, Yorktown Heights, NY (US)

Correspondence Address: Jack E. Haken, Corporate Patent Counsel, U.S. Philips Corporation, 580 White Plains Road, Tarrytown, NY, 10591, US

(73) Assignee: Philips Electronics North America Corp.

(21) Appl. No.: 09/725,970

(22) Filed: Nov. 29, 2000

(51) Int. Cl. G06F 15/00

(52) U.S. Cl. 707/513

(57) ABSTRACT

A wireless telephone, personal digital assistant (PDA), smart remote control, or other Internet-enabled processing device includes a scalable parser which supports a designated subset of an extensible mark-up language (XML) grammar. The designated subset may be selected for a given device based on factors such as the computational and memory capabilities of that device, and the complexity of documents handled by that device. An XML document supplied to the device is parsed using the scalable parser. The results of the parsing may then be supplied via a well-known standard application programming interface (API) to an application program on the processing device, and used to control an operation of the device. Advantageously, the invention allows “thin” devices to process simple XML documents without requiring implementation of the complete XML grammar.

### FIELD OF THE INVENTION

The present invention relates generally to mark-up languages for use in conjunction with the delivery of information over a computer network such as the Internet, and more particularly to parsers for processing information configured using extensible mark-up language (XML).

### BACKGROUND OF THE INVENTION

Extensible mark-up language (XML) is fast becoming the dominant language for e-commerce, web portals, content services and other important information processing applications implemented on the Internet. The XML standard describes a class of data objects called XML documents and the behavior of computer programs which process such documents. XML is an application profile or restricted form of the standard generalized mark-up language (SGML). XML documents are made up of storage units called entities, which contain either parsed or unparsed data. Parsed data is made up of characters, some of which form character data, and some of which form markup. Markup for a given XML document encodes a description of the storage layout and logical structure of that document. XML provides a mechanism to impose constraints on the storage layout and logical structure. Additional details regarding conventional XML may be found in XML 1.0 (Second Edition), World Wide Web Consortium (W3C) Recommendation, October 2000, www.w3.org/TR/REC-xml, which is incorporated by reference herein.

An XML parser may be viewed as a software library used to facilitate XML document manipulations. Most conventional XML parsers are configured for compatibility with the entire XML 1.0 grammar, and thus require relatively large software components. Examples of conventional XML parsers include the Xerecs-J and Xerecs-C parsers, and the XP parser. Standard application programming interfaces (APIs) are used to provide predefined interfaces for one or more of these parsers. These APIs include DOM 1.0, described in Document Object Model (DOM) Level 1 Specification, Version 1.0, W3C Recommendation, October 1998, www.w3.org/TR/1998/REC-DOM-Level-1-19981001, which is incorporated by reference herein, and SAX, described in SAX 2.0, “The Simple API for XML,” www.megginson.com/SAX/sax.html, which is incorporated by reference herein. The above-noted Xerecs-J and Xerecs-C parsers implement both the DOM and SAX APIs, while the XP parser implements only the SAX API.

As previously noted, a significant drawback of the above-described conventional parsers is that such parsers are generally configured for compatibility with the entire XML 1.0 grammar. This can be particularly problematic for so-called “thin” devices, such as wireless telephones, personal digital assistants (PDAs), smart remote controls, etc. Such devices are often configured to provide access to information available over the Internet. Internet access may be provided in these devices through wired connections, wireless connections or combinations thereof, using well-known conventional communication protocols such as the Internet Protocol (IP). However, thin devices typically have limited computing power and memory. As a result, conventional XML parsers of the type described above are generally not suitable for use in thin devices.

### SUMMARY OF THE INVENTION

The present invention solves one or more of the above-identified problems of the prior art by providing a scalable extensible mark-up language (XML) parser.

In accordance with one aspect of the invention, a wireless telephone, personal digital assistant (PDA), smart remote control, or other Internet-enabled processing device includes a scalable parser which supports a designated subset of an XML grammar. The designated subset may be selected for a given device based on factors such as the computational and memory capabilities of that device, and the complexity of the handled documents. An XML document supplied to the device is parsed using the scalable parser. The results of the parsing may then be supplied via a well-known standard application programming interfaces (API) to an application program on the processing device, and may be used to control an operation of the device, such as presentation of XML document information to a user.

In an illustrative embodiment of the invention, the scalable parser may be implemented as a micro XML parser which implements a first subset of the complete XML grammar, or as a macro XML parser which implements a second subset of the complete XML grammar, where the second subset is a superset of the first subset.

Advantageously, the invention allows “thin” devices and other types of Internet-enabled devices to process simple XML documents without requiring implementation of the complete XML 1.0 grammar. A scalable XML parser in accordance with the invention is scalable to the computational and memory capabilities of a given processing device, or other device-specific factors, such that the device can be used to process XML documents in an efficient manner.

These and other features and advantages of the present invention will become more apparent from the accompanying drawings and the following detailed description.

### BRIEF DESCRIPTION OF THE DRAWINGS

FIG. 1 is a diagram showing the functionality of a scalable extensible mark-up language (XML) parser in accordance with an illustrative embodiment of the invention.

FIG. 2 shows one possible implementation of a device in which the scalable XML parser of FIG. 1 may be implemented.

FIG. 3 shows an example of a communication system in which the scalable XML parser of FIG. 1 may be implemented.

FIG. 4 illustrates the placement of the scalable XML parser of FIG. 1 in a software stack in the illustrative embodiment of the invention.

FIG. 5 is a state diagram illustrating an example parsing process that may be implemented in a scalable XML parser in accordance with the invention.

FIG. 6 illustrates different subsets of a complete XML grammar that may be implemented by scalable parsers in accordance with the invention.

FIG. 7 illustrates that different types of devices can utilize different parsers each implementing different subset levels of a complete XML grammar.

### DETAILED DESCRIPTION OF THE INVENTION

FIG. 1 is a diagram showing the processing of a simple extensible mark-up language (XML) document 10 using a scalable XML parser in accordance with an illustrative embodiment of the invention. The simple XML document 10 represents an example of a type of document that can be processed using less than the full XML 1.0 grammar. Processing the XML document 10 using a conventional XML 1.0 parser results in an output 14. The present invention in the illustrative embodiment of FIG. 1 provides a micro XML parser 15 which receives as an input the XML document 10 and generates substantially the same output 14 as is generated by the complete XML 1.0 parser 12.

As will be described in greater detail below, the micro XML parser is one example of a type of scalable XML parser which implements a designated subset of the XML grammar appropriate to the computing power and memory capabilities of a thin device. Other embodiments of the invention can provide other types of XML parsers scaled to the particular computation and memory capabilities of other types of processing devices. The term “scalable parser” as used herein is intended to include any parser which can be configured or is configured to support one or more designated subsets of a given complete language grammar.

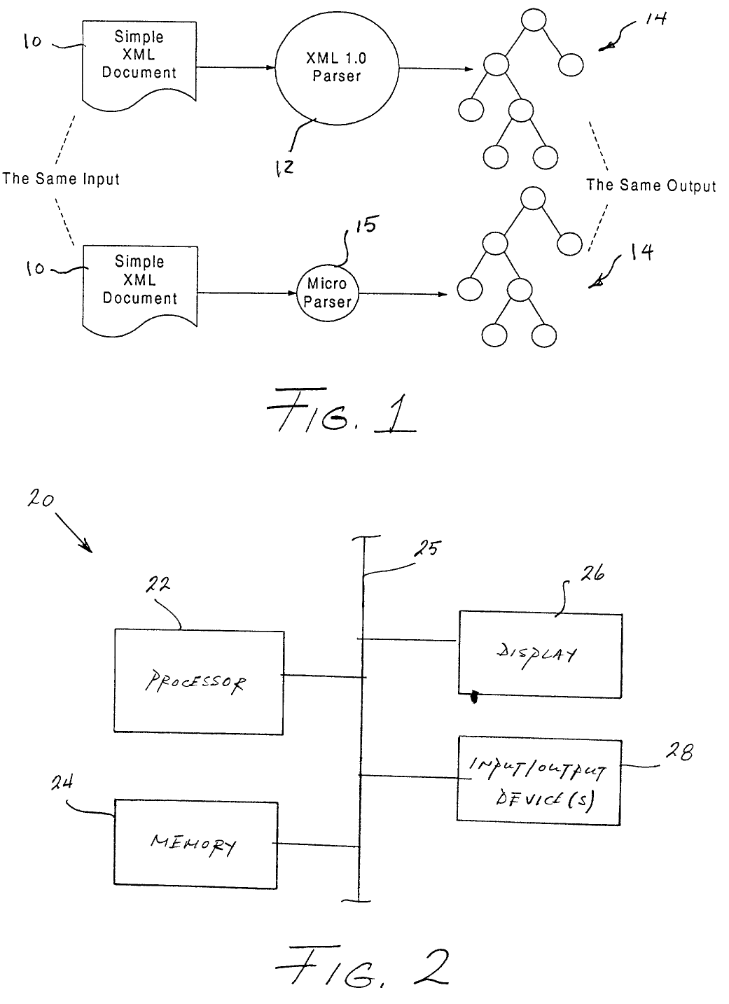

FIG. 2 shows an example of a processing device 20 in which the micro XML parser 15 of FIG. 1 or other scalable XML parser of the present invention may be implemented. The device 20 includes a processor 22 and a memory 24 which communicate over at least a portion of a set 25 of one or more system buses. Also utilizing at least a portion of the set 25 of system buses are a display 26 and one or more input/output (I/O) devices 28. The device 20 may represent a wireless telephone, personal digital assistant (PDA), portable computer, smart remote control, or other type of processing device. The elements of the device 20 may be conventional elements of such devices. For example, the processor 22 may represent a microprocessor, central processing unit (CPU), digital signal processor (DSP), or application-specific integrated circuit (ASIC), as well as portions or combinations of these and other processing devices. The memory 24 is typically an electronic memory, but may comprise or include other types of storage devices, such as disk-based optical or magnetic memory.

The XML parsing techniques described herein may be implemented in whole or in part using software stored and executed using the respective memory and processor elements of the device 20. For example, the micro XML parser 15 of FIG. 1 may be implemented at least in part using one or more software programs stored in memory 24 and executed by processor 22. The particular manner in which such software programs may be stored and executed in device elements such as memory 24 and processor 22 is well understood in the art and therefore not described in detail herein.

It should be noted that the device 20 may include other elements not shown, or other types and arrangements of elements capable of providing the scalable XML parsing functions described herein.

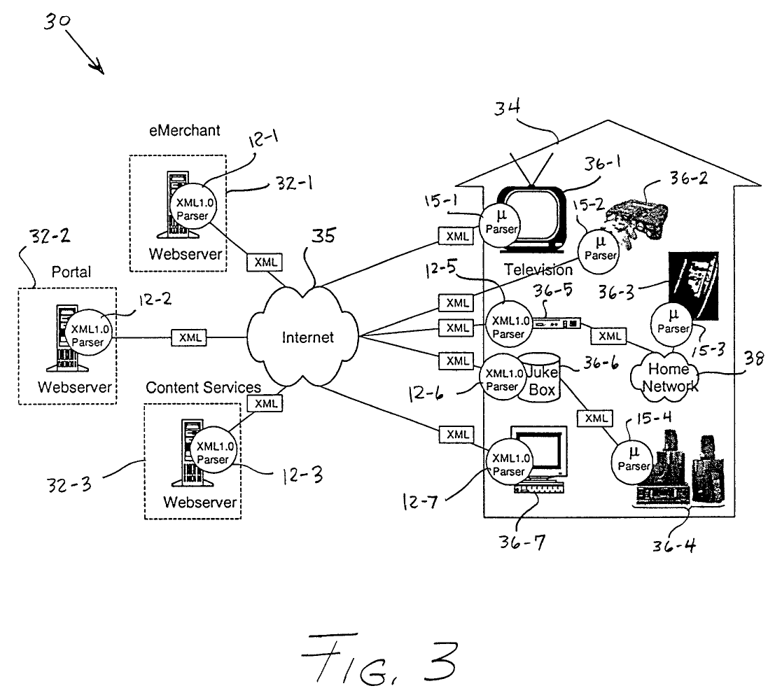

FIG. 3 shows an example of an Internet-based communication system 30 in which the micro XML parser 15 of FIG. 1 may be implemented. The system 30 includes a number of web servers 32-1, 32-2 and 32-3 which communicate with a number of devices in a home 34 via the Internet 35. The web servers 32-1, 32-2 and 32-3 are associated with an e-commerce merchant (eMerchant), a web portal and a source of content services, respectively. Each of the web servers 32-1, 32-2 and 32-3 is equipped with a corresponding conventional XML 1.0 parser 12-1, 12-2 and 12-3. These servers deliver XML documents such as document 10 of FIG. 1 over the Internet 35 to devices in the home 34, using well-known techniques such as Internet protocol (IP).

The devices in the home 34 in this embodiment include a number of devices equipped with the micro XML parser 15 and a number of devices equipped with the complete XML 1.0 parser 12. More particularly, the home 34 includes a television 36-1, a video game console 36-2, a smart remote control 36-3 and a stereo system 36-4 which are equipped with respective micro XML parsers 15-1, 15-2, 15-3 and 15-4, and a set-top box 36-5, a juke box 36-6, and a personal computer 36-7 which are equipped with respective XML 1.0 parsers 12-5, 12-6 and 12-7. One or more of the devices 36 may be configured in the manner shown in FIG. 2. The home 34 further includes a home network 38 which provides in this example an interface between devices 36-3 and 36-5.

The XML documents sent over the Internet 35 from the web servers 32 to the devices 36 are processed using the corresponding parsers. In the case of one of the micro XML parsers 15, the XML document is processed using a designated subset of the complete XML 1.0 grammar in a manner which is compatible with the computation and memory capabilities of the corresponding device.

It should be noted that the particular arrangement and configuration of elements shown in system 30 of FIG. 3 are by way of example only. In other embodiments, other types of web servers, networks and devices may be used. Those skilled in the art will recognize that the scalable XML parsing techniques of the present invention do not require any particular arrangement or configuration of such system elements.

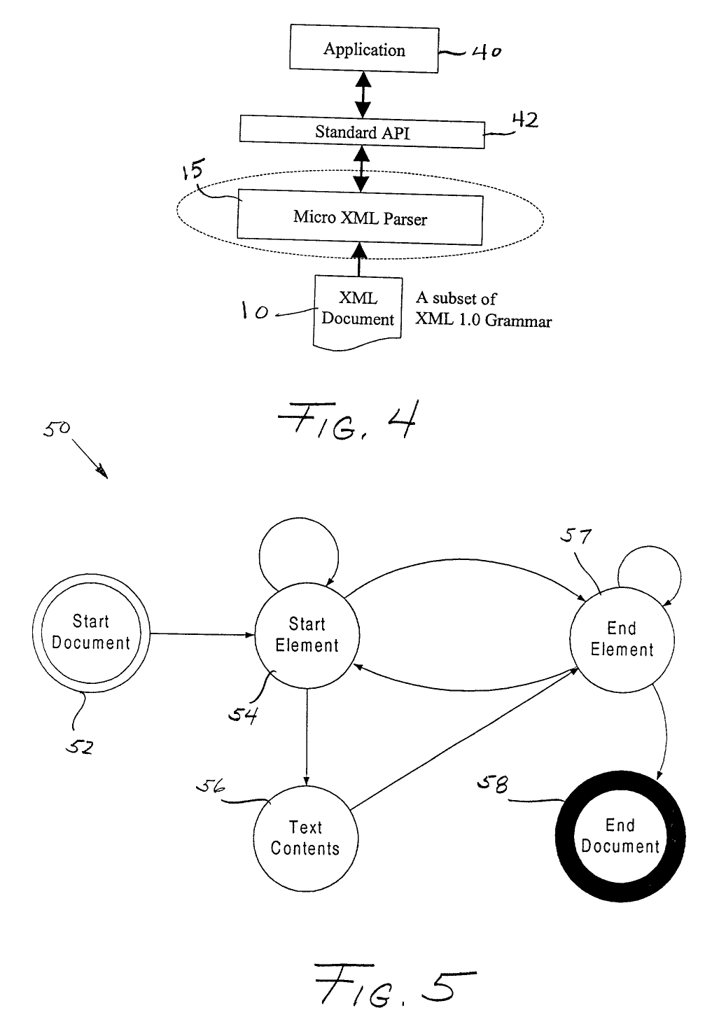

FIG. 4 shows a software stack associated with a given device which includes the micro XML parser 15. The given device may be one of the devices 36-1, 36-2, 36-3 or 36-4 of FIG. 3, or any other suitable processing device. An application program 40 runs at the top of the stack, and interfaces with a standard API 42. The standard API 42 may be the DOM or SAX APIs previously described, or other well-known standard API. Other types of APIs may also be used. The micro XML parser 15 is designed to support one or more of these standard APIs. The micro XML parser 15 supports a designated subset of the XML 1.0 grammar suitable for processing the XML document 10.

In operation, the micro XML parser 15 parses the XML document 10 using the designated subset of the XML 1.0 grammar, and passes information from the document 10 to the application 40 via the standard API 42. The application program 40 then utilizes a result of the parsing by micro XML parser 15 to control an operation of the associated processing device. For example, the application program may process information received from the micro XML parser via the standard API such that the information is presented in a visually-perceptible manner on a display of the device. As another example, the application program may present the information in an audibly-perceptible manner using a speaker associated with the device. Numerous other operations of the device may be controlled based on a result of the parsing implemented by the micro XML parser 15.

FIG. 5 is a state diagram 50 illustrating an example parsing process that may be implemented in the micro XML parser in accordance with the present invention. The state diagram 50 includes a start document state 52, a start element state 54, a text contents state 56, an end element state 57, and an end document state 58, all arranged as shown. In one possible embodiment of the invention, the micro XML parser 15 processes a given XML document 10 in accordance with the state diagram 50, although other types of state-based processing may be used in other embodiments. State-based processing similar to that shown in FIG. 5 may also be used with other parsers configured in accordance with the present invention.

As noted previously, the micro XML parser supports a designated subset of a complete XML 1.0 grammar, rather than the complete grammar, so as to be compatible with the limited computation and memory resources of a thin device such as a wireless telephone, PDA or smart remote control. A more specific example of one designated subset of the complete XML grammar that may be supported by the micro XML parser 15 to provide the state-based processing of FIG. 5 is as follows:

| | | |
|---|---|---|
| [1] document | ::= | element* |
| [2] element | ::= | STag content ETag |
| [3] STag | ::= | ‘<’ S? Name S? ‘>’ |
| [4] ETag | ::= | ‘</’ Name ‘>’ |
| [5] content | ::= | element* \| Char* |
| [6] Name | ::= | Char* |
| [7] Char | ::= | #x9 \| #xA \| #xD \| [#x20−#xD7FF] \| [#xE000− |
| | | xFFFD] \| [#x10000−#x10FFFF] /* any Unicode |
| | | character, excluding the surrogate blocks, |
| | | EFFE, and FFFF. */ |

Such a subset of the complete XML 1.0 grammar can be used to describe numerous commonly-used XML documents in an efficient manner. The subset allows information from the documents to be processed for presentation on a thin device without requiring the thin device to implement a parser supporting the complete XML 1.0 grammar.

In the illustrative embodiments described above, the micro XML parser supports a designated subset of the complete XML 1.0 grammar, so as to provide XML capabilities with the limited computation and memory resources available on a thin device. In other embodiments of the invention, the designated subset of the complete XML 1.0 grammar may be a larger subset than that used for the micro XML parser 15. More particularly, the designated subset may be any subset that is selected as being appropriate to the processing and memory capabilities of the particular device.

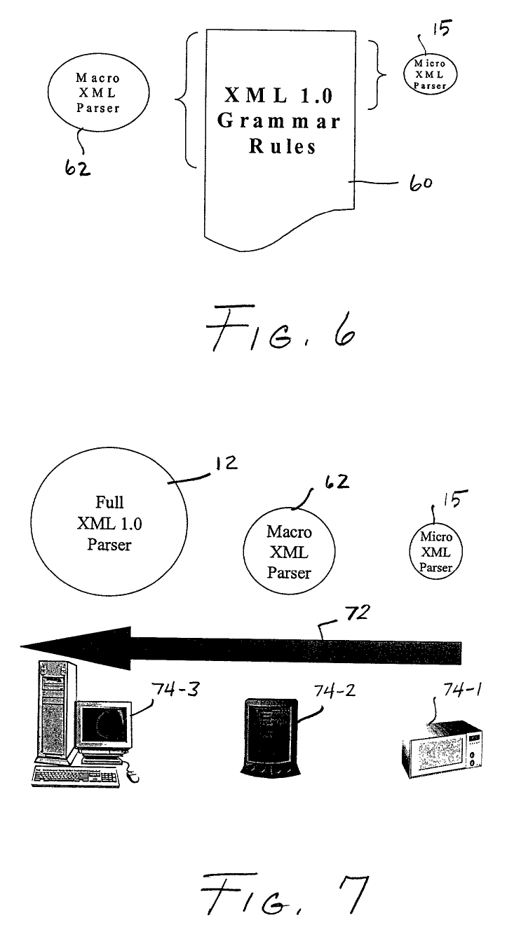

FIG. 6 shows an example of an alternative embodiment of the invention in which the designated subset of the complete XML grammar is larger than that described above for the micro XML parser 15. The complete XML 1.0 grammar is represented by a set of rules 60. The designated subset of the rules supported by the micro XML parser 15 is shown by the bracket on the right. The bracket on the left shows a larger subset of the rules that is supported by a macro XML parser 62. It should be noted that the macro XML parser 62 still supports less than the complete XML 1.0 grammar, and therefore is suitable for use with devices that cannot easily support the full grammar, but which have sufficient processing and memory capability to support more than the designated subset associated with the micro XML parser 15.

A more specific example of one designated subset of the complete XML grammar that may be supported by the macro XML parser 62 is as follows:

| | | |
|---|---|---|
| [1] document | ::= | element* |
| [2] element | ::= | STag content ETag \| EmptyElemTag |
| [3] Stag | ::= | ‘<’ Name ‘>’ \| ‘<’ Name [AttName Eq |
| | | AttrValue]* ‘/>’ |
| [4] ETag | ::= | ‘21/’ Name ‘>’ |
| [5] content | ::= | element* \| Char* \| PI |
| [6] Name | ::= | Char* |
| [7] Char | ::= | #x9 \| #xA \| #xD \| [#x20−#xD7FF] \| |
| | | [#xE000−xFFFD] \| [#x10000−#10FFFF] |
| | | /* any Unicode character, excluding |
| | | the surrogate blocks, FFFE, and |
| | | FFFF.*/ |
| [8] EmptyElemTag | ::= | ‘<’ Name (S Attribute) * S? ‘/>’ |
| [9] Eq | ::= | S? ‘=’ S? |
| [10] AttName | ::= | Name |
| [11] AttValue | ::= | ‘ “ ’ Name ‘ ” ’ |
| [12] S | ::= | (#x20 \| #x9 \| #xD \| #xA) + |
| [13] PI | ::= | ‘<?’ PITarget (S (Char* − (Char* ‘?>’ |
| | | Char*)))? ‘?>’ |
| [14] PITarget | ::= | Name − ((‘X’ \| ‘x’) \| (‘M’ \| ‘m’) (‘L’ |
| | | ‘l’)) |

It should be understood that the example XML grammar subsets provided herein in conjunction with description of the micro XML parser 15 and the macro XML parser 62 are for illustrative purposes only, and not intended to limit the scope of the invention in any way. Those skilled in the art will recognize that the invention can be implemented using other grammar subsets. The particular element terminology utilized in the example grammar subsets given above is described in the above-cited XML 1.0 Recommendation document, and will therefore not be further described herein.

FIG. 7 illustrates in greater detail a substantial continuum of scalability that may be provided in accordance with the present invention. The scalability continuum is represented by an arrow 72 in the direction of increasing device complexity from a simple Internet-enable appliance 74-1, through a PDA 74-2 up to a desktop personal computer 74-3. The micro XML parser 15 is used for the simple appliance 74-1, while the macro XML parser 62 is used for the PDA 74-2, and the full XML 1.0 parser 12 is used for the personal computer 74-3. The diagram in FIG. 7 thus illustrates that the particular subset of the XML 1.0 grammar supported by a scalable parser in accordance with the present invention may be selected based on the particular computational and memory resources of the corresponding processing device.

A given parser in accordance with the invention may, but need not, be capable of supporting two or more different subsets of the complete XML 1.0 grammar. For example, a given embodiment of the invention may be implemented as a set of software programs having a number of different parsers suitable for downloading into different types of devices. Other embodiments could be implemented as a single parser that is downloaded into or otherwise incorporated into a given processing device. The term “scalable parser” as used herein is therefore intended to include any type of parser that is capable of parsing a document using a designated subset of a complete grammar.

The above-described embodiments of the invention are intended to be illustrative only. For example, the invention can be used in other types of information processing systems and devices using other arrangements of processing elements. In addition, as indicated above, the particular subset of the complete XML grammar implemented within a given scalable XML parser of the present invention may vary depending upon the computational and memory capabilities of the corresponding device. These and numerous other embodiments within the scope of the following claims will be apparent to those skilled in the art.

What is claimed is:

1. A method for processing information in a processing device configured to support an extensible mark-up language, the method comprising the steps of:
parsing an extensible mark-up language document using a parser based on a designated subset of a complete extensible mark-up language grammar; and
utilizing a result of the parsing step to control an operation of the processing device.

2. The method of claim 1 wherein the parser comprises a scalable parser capable of implementing a plurality of different subsets of the complete extensible mark-up language grammar.

3. The method of claim 2 wherein the scalable parser comprises at least one of a micro XML parser which implements a first subset of the complete extensible mark-up language grammar and a macro XML parser which implements a second subset of the complete extensible mark-up language grammar.

4. The method of claim 3 wherein the second subset is a superset of the first subset.

5. The method of claim 1 wherein the utilizing step comprises presenting information associated with at least a portion of the document to a user via the processing device.

6. The method of claim 5 wherein the information is presented in a visually-perceptible manner on a display of the device.

7. The method of claim 5 wherein the information is presented in an audibly-perceptible manner using a speaker associated with the device.

8. The method of claim 1 wherein the processing device comprises a wireless telephone.

9. The method of claim 1 wherein the processing device comprises a personal digital assistant.

10. The method of claim 1 wherein the processing device comprises a remote control device.

11. The method of claim 1 wherein the designated subset of the complete extensible mark-up language grammar comprises one or more of the following elements:

| | | |
|---|---|---|
| [1] document | ::= | element* |
| [2] element | ::= | STag content ETag |
| [3] STag | ::= | ‘<’S? Name S?‘>’ |
| [4] ETag | ::= | ‘</’ Name ‘>’ |
| [5] content | ::= | element* \| Char* |
| [6] Name | ::= | Char* |
| [7] Char | ::= | Unicode characters |

12. The method of claim 1 wherein the designated subset of the complete extensible mark-up language grammar comprises a subset selected from a substantial continuum of a plurality of different subsets of increasing complexity, the subset being selected based at least in part on computational and memory resources of the processing device.

13. An apparatus for processing information in an extensible mark-up language, the apparatus comprising:
a processing device operative to parse an extensible mark-up language document using a parser based on a designated subset of a complete extensible mark-up language grammar, wherein a result of the parsing by the parser is utilized to control an operation of the processing device.

14. An article of manufacture comprising a machine-readable storage medium containing one or more software programs for processing information in a processing device configured to support an extensible mark-up language, wherein the one or more software programs when executed implement the steps of:
parsing an extensible mark-up language document using a parser based on a designated subset of a complete extensible mark-up language grammar; and
utilizing a result of the parsing step to control an operation of the processing device.
